(19) United States
(12) Patent Application Publication
(10) Pub. No.: US 2009/0265738 A1
(43) Pub. Date: Oct. 22, 2009

(54) METHOD FOR DYNAMICALLY DISPLAYING AUXILIARY DISPLAY DATA

(76) Inventor: Kung-Lieh Liao, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/237,400

(22) Filed: Sep. 25, 2008

(30) Foreign Application Priority Data
Apr. 22, 2008 (CN) 200810092329.X

(51) Int. Cl. H04N 5/445

(52) U.S. Cl. 725/40

(57) ABSTRACT

A method for dynamically displaying an auxiliary display data on a screen includes the following steps: (a) receiving a message carrier, and storing at least a data transmitted via the message carrier into a storage device; (b) comparing a received data of the message carrier and a stored data in the storage device; and when the received data differs from the stored data, storing the received data into the storage device for updating the stored data, thereby generating an updated stored data stored in the storage device; and (c) determining whether to display the auxiliary display data corresponding to an altered portion or not, wherein when the auxiliary display data is displayed, an adjusting operation is performed according to the updated stored data to thereby display the auxiliary display data on the screen.

### BACKGROUND OF THE INVENTION

1. Field of the Invention

The present invention relates to video display schemes, and more particularly, to a method for dynamically displaying an auxiliary display data on a screen of an electronic device (e.g., a digital television).

2. Description of the Prior Art

Owing to the fast development of modern technology, an increasing number of digital television devices comply with a digital television broadcasting system to be available to the public. Compared to a traditional analog television broadcasting system that complies with a national television standard committee (NTSC) standard, the digital television broadcasting system converts a television signal from an analog signal into a digital signal.

The digital television broadcasting system includes several different standards: Advanced Television Systems Committee (ATSC), Digital Video Broadcasting-Terrestrial (DVB-T), and Terrestrial Integrated Services Digital Broadcasting (ISDB-T), etc. There are still more standards, for instance, Mainland China has built up Digital Terrestrial Multimedia Broadcast (DTMB) as its own standard. It is necessary, however, to utilize a digital television receiver for receiving the digital television signal no matter which standard is chosen by the digital television device.

When a user watches a digital TV channel through the digital television device and/or through other electronic entertainment devices, there is still a lack of a convenient, real-time auxiliary display data function for providing a search/browse function so the user does not have to interrupt a currently viewed program of the digital channel while searching/browsing related index data for program data of other digital channels.

For instance, providers of digital TV programs may provide a corresponding electronic program guide (EPG) utilizing the digital TV signal, enabling the user to search/browse for related information of the digital TV programs. The electronic program guide (EPG) shows complete display time buckets and program information of each digital channel. When the user wants to search the following time buckets of the currently selected channel and/or other channels, the user has to press a corresponding EPG button for displaying the EPG list. The traditional EPG only has a full screen option for displaying all details concerning date, time, channel number, channel name, program name, and a runtime of the following programs, etc; the traditional full screen display not only contains too much trivial data but forces the user to interrupt watching the currently selected channel (program) to browse the traditional full screen EPG. In addition, since the number of digital channels is increasing rapidly, it becomes clear there remains considerable room for improvement of display methods of EPG.

### SUMMARY OF THE INVENTION

It is therefore an objective of the present invention to solve the aforementioned problems, and to provide a method for dynamically displaying an auxiliary display data. In addition, the method for dynamically displaying an auxiliary display data enables the user to receive the desired personal reminder data after setting/enabling the required reminder function(s) and watch the digital channel simultaneously by displaying the personal reminder data on a portion of the screen only.

Moreover, the disclosed invention can also be applied to other electronic devices as well as the aforementioned digital TV devices, for instance, a portable multimedia device (e.g., MP3 player) having a screen.

According to one embodiment of the present invention, a method for dynamically displaying an auxiliary display data on a screen is disclosed. The method includes: (a) receiving a message carrier, and storing at least a data transmitted via the message carrier into a storage device; (b) comparing a received data of the message carrier and a stored data in the storage device; and when the received data differs the stored data, storing the received data into the storage device for updating the stored data, thereby generating an updated stored data stored in the storage device; and (c) determining whether to display the auxiliary display data corresponding to an altered portion or not, wherein an adjusting operation is performed according to the updated stored data when the auxiliary display data is displayed, to thereby display the auxiliary display data on the screen.

According to another embodiment of the present invention, a method for dynamically displaying an auxiliary display data on a screen is disclosed. The method includes: regularly checking if a display condition for the auxiliary display data is met; and when the display condition for the auxiliary display data is met, combining the auxiliary display data with a main display data to thereby generate an adjusted main display data and displaying the adjusted main display data; wherein the adjusted main display data contains the auxiliary display data.

The present invention provides the user a method of conveniently browsing the auxiliary display data on a screen (e.g., a display) by utilizing a short message display interface. Therefore the user can use the simple and convenient operating scheme when watching the digital TV channels by firstly setting the user requirements on a reminder menu and combining the short message display interface, the reminder function list, and an automatic matching management.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a reminder menu of the electronic device (e.g., a digital TV device) according to an embodiment of the present invention.

FIG. 2 is an updating flow of the EPG according to an embodiment of the present invention

FIG. 3 is a flow chart illustrating dynamic displaying of an auxiliary data of the EPG on the screen according to an embodiment of the present invention.

FIG. 4 is a diagram illustrating displaying the auxiliary display data of the present invention on the screen.

FIG. 5 is a diagram illustrating displaying the auxiliary display data of the EPG on the screen.

FIG. 6 is a diagram illustrating utilizing the short message display interface to browse the auxiliary display data of other channels on the screen according to an embodiment of the present invention.

FIG. 7 is a diagram illustrating utilizing the short message display interface to browse the auxiliary display data of other channels on the screen according to another embodiment of the present invention.

FIG. 8. is a flow chart illustrating dynamic displaying of an auxiliary data of the favorite programs (the “favorite” function) according to an embodiment of the present invention.

FIG. 9 is a diagram illustrating an embodiment of displaying the auxiliary display data corresponding to the favorite programs on the screen coupled to the digital television device (set up box).

FIG. 10 is a diagram illustrating another embodiment of displaying the auxiliary display data corresponding to the favorite programs on the screen coupled to the digital television device (set up box).

FIG. 11 is a flow chart illustrating dynamic displaying of the auxiliary data corresponding to the PVR function according to an embodiment of the present invention.

FIG. 12 is a diagram illustrating displaying the auxiliary display data of an under-recorded program on the screen when the recording operation starts.

FIG. 13 is a diagram illustrating displaying the auxiliary display data of the under-recorded program on the screen during the recording operation.

### DETAILED DESCRIPTION

For simplicity, in the following description, the digital television broadcasting system and the digital TV system are interchangeable terms. In addition, the electronic device in the following disclosure is a digital TV device complying with a digital TV system. The digital TV device complying with the digital TV system is not a limitation of the present invention; that is, the disclosed invention can also be applied to other electronic devices with a display function/broadcasting function; these alternative designs also fall within the scope of the present invention.

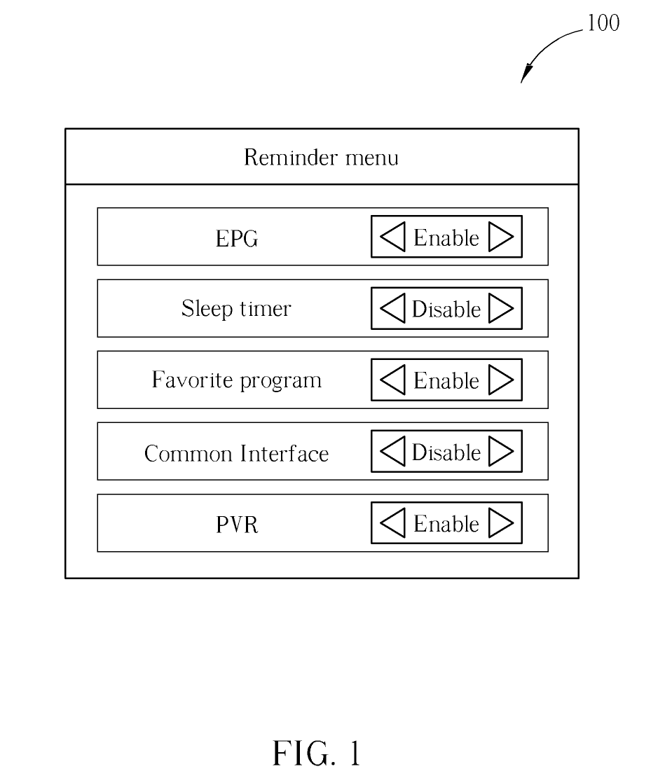

Please refer to FIG. 1. FIG. 1 is a diagram illustrating a reminder menu of the electronic device (e.g., a digital TV device) according to an embodiment of the present invention. As shown in FIG. 1, the reminder menu 100 includes a plurality of reminder functions, such as “EPG” function, “Sleep timer” for turning off the digital electronic device, “Favorites” for setting favorite programs of the user, “Common Interface” (CI) for display a current payment certificate state, and “PVR” (personal video recorder) for setting under-recorded programs by the user, etc.

When the user turns on the digital TV device (e.g., a set top box, STB) for watching digital TV programs, the digital TV device (e.g., a set top box, STB) keeps accessing a plurality of related information (e.g., channel, date, time, program, etc.) of the EPG transmitted via a message carrier (a multimedia carrier), and stores the related information into a storage device (e.g., a memory or a database) as the stored data. In this embodiment, the storage device is a volatile memory such as a dynamic random access memory (DRAM), and the setting of the reminder menu by the user is stored into a non-volatile memory, e.g., a flash memory.

In this embodiment, the digital TV device (set top box, STB) regularly receives the related information of the EPG and compares the received data (the EPG data) and the stored data (stored data in the database), and the system executes an adjusting operation (e.g., writing the altered portion into the database) to store the received data into the storage device for updating the stored to thereby generate an updated stored data when the received data differs the stored data.

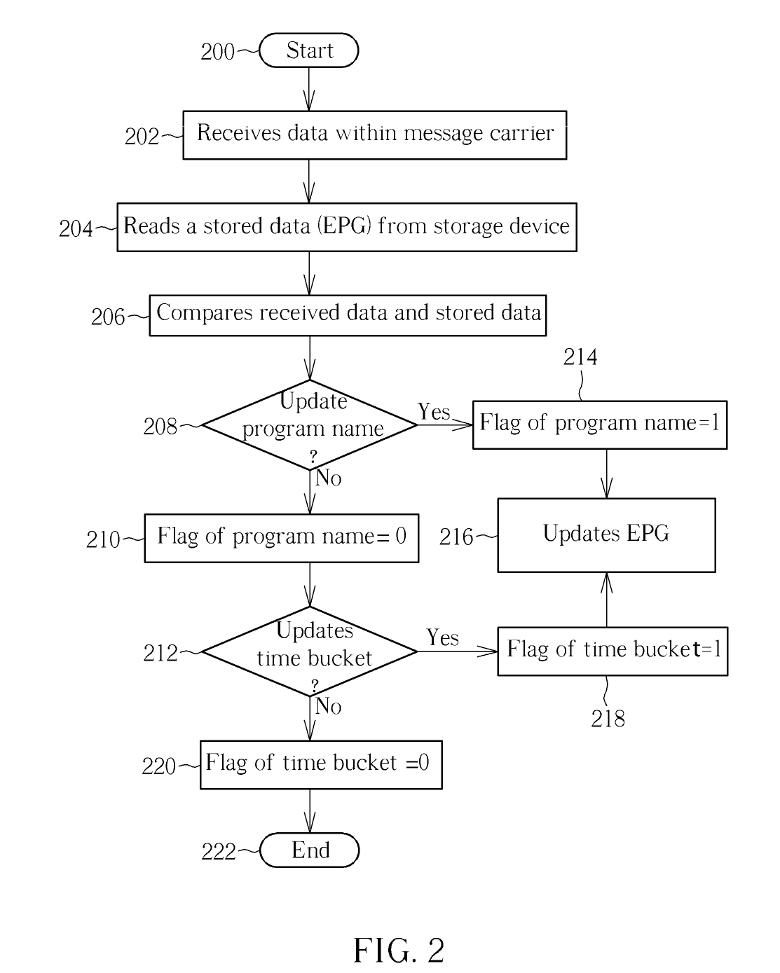

Please refer to FIG. 2. FIG. 2 is an updating flow of the EPG according to an embodiment of the present invention. Please note that, if the result is substantially the same, the steps are not limited to be executed according to the exact order shown in FIG. 2. The flow includes the following steps:

Step 200: The updating flow of the EPG starts.

Step 202: The digital TV device (set top box) receives a message carrier (e.g., a TV carrier), and stores at least a data (e.g., EPG) transmitted via the message carrier into a storage device.

Step 204: Read a stored data (EPG) from a storage device (database).

Step 206: Compare a received data and the stored data (i.e., compare the received EPG and the data of stored EPG within the database).

Step 208: Does program name of the stored data (EPG) in the database require updating or not? If yes, go to step 214; otherwise, go to step 210.

Step 210: Set a flag value corresponding to the program name as “0”.

Step 212: Is it required to update at least a time bucket of the stored data (EPG) in the database or not? If yes, go to step 218; otherwise, go to step 220.

Step 214: Set a flag value corresponding to the program name as “1”.

Step 216: Update the data of EPG stored in the storage device.

Step 218: Set a flag value corresponding to the time bucket as “1”.

Step 220: Set a flag value corresponding to the time bucket as “0”.

Step 222: End.

By the disclosed updating flow, the present invention enables the user to easily display/browse the EPG and other reminder functions of the reminder menu on a screen (e.g., a screen of a displayer). For instance, by the present invention, the user can easily browse the favorite program set by the user (by the “Favorites” function), and/or set the under-recorded program by the user (by the “PVR” function), etc.

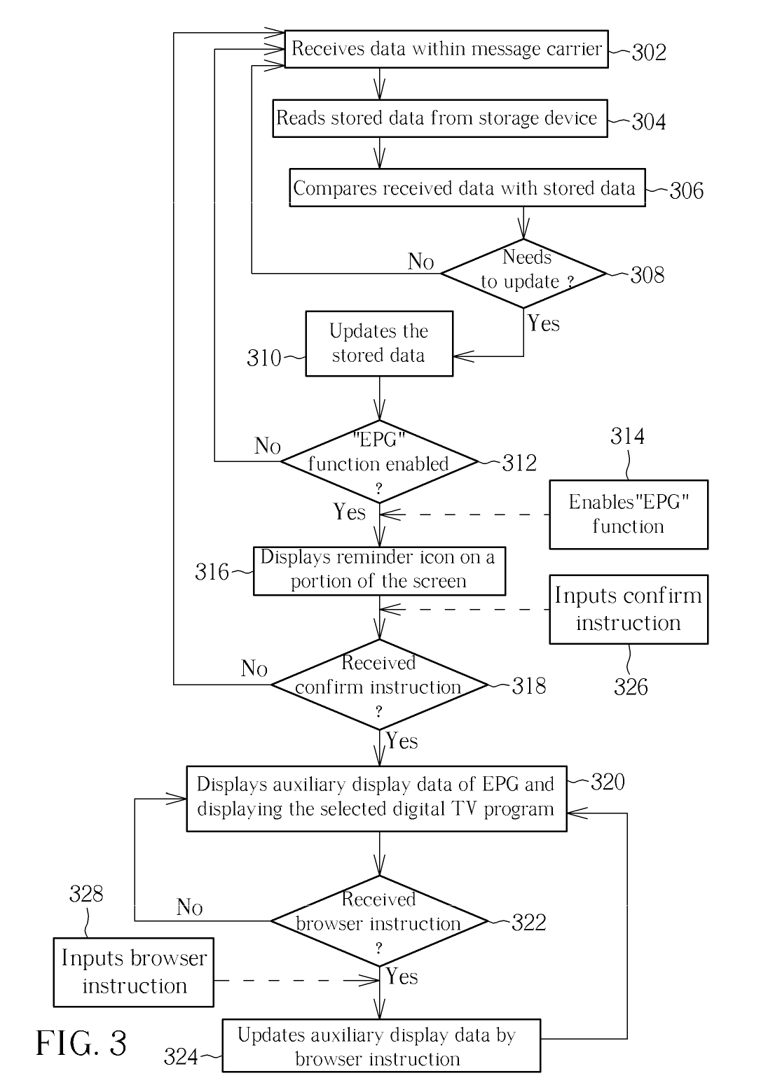

Please refer to FIG. 3. FIG. 3 is a flow chart illustrating dynamic displaying of an auxiliary data of the EPG on the screen according to an embodiment of the present invention. Please note that, if the result is substantially the same, the steps are not limited to be executed according to the exact order shown in FIG. 3. The flow includes the following steps:

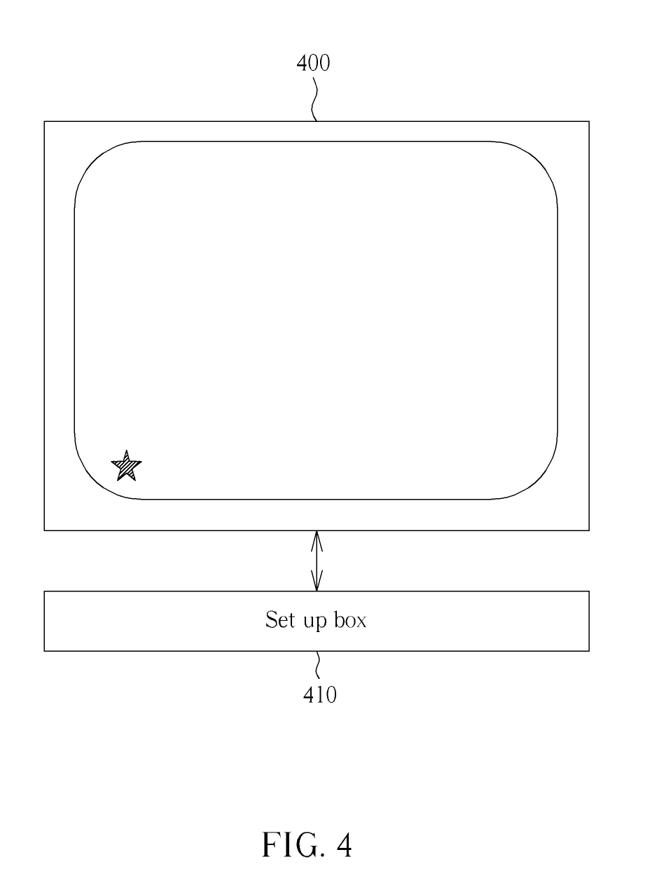

Step 302: The digital TV device (the set top box 410 of FIG. 4) receives a message carrier (e.g., a TV carrier), and stores at least a data (e.g., EPG) transmitted via the message carrier into a storage device.

Step 304: Read the stored data (EPG) from the storage device (the database).

Step 306: Compare the received data with the stored data (i.e., compare the received EPG and the data of stored EPG within the database).

Step 308: Is it required to update the stored data (EPG) in the database or not? If yes, go to step 310; otherwise, go to step 302.

Step 310: Update the stored data (e.g., store the updated EPG into the database).

Step 312: The digital TV device (the set top box 410 of FIG. 4) checks if the “EPG” function therein the reminder menu 100 is enabled or nor? If yes, go to step 316; otherwise, go to step 302.

Step 316: Display a reminder icon (e.g., a star sign in this embodiment) on a portion of the screen 400 of the digital TV device (the set top box 410 shown in FIG. 4); the screen 400 simultaneously displays the program of the selected channel. (FIG. 4 is a diagram illustrating displaying the auxiliary display data of the present invention on the screen 400, wherein the screen 400 is coupled to a set up box 410. Furthermore, in the following description, the set up box 410 has a PVR (personal video recorder) function; however, this is only for illustration purposes and is not intended as a limitation to the present invention. Other set up boxes without the PVR function still obey the spirit of the present invention and fall within the scope of the present invention.

Step 318: Check if a confirmation instruction from the user is received or not for confirming to display the disclosed simplified EPG data? If yes, go to step 320; otherwise, go to step 302.

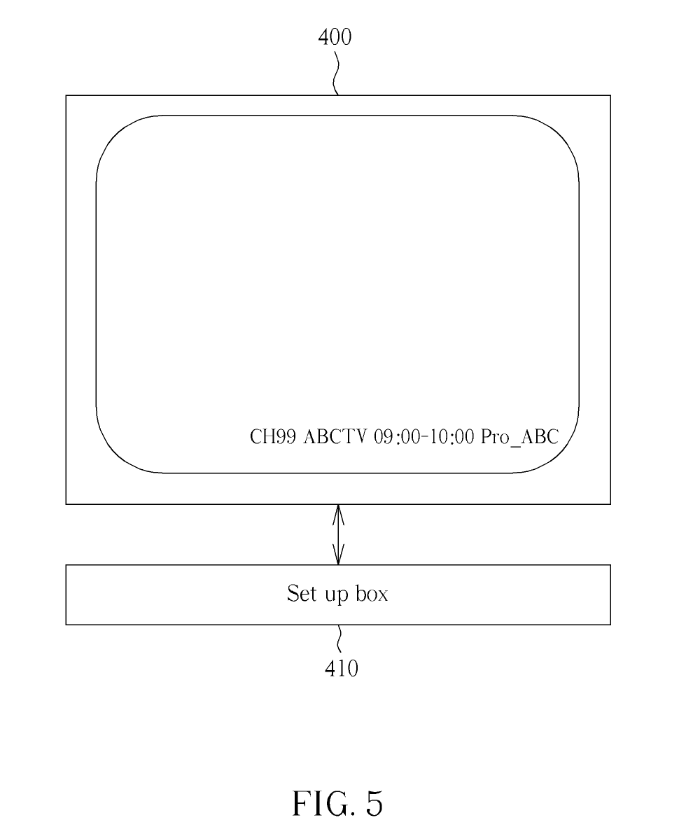

Step 320: Display the auxiliary display data of the EPG at a portion (partial area) of the screen 400 while displaying the selected digital TV program on the digital TV device (the set top box 410), wherein the auxiliary display data is displayed on a portion of the screen 400 by a message line (as shown in FIG. 5).

Step 322: Check if a browse instruction (e.g., an instruction inputted by a direction key) from the user is received or not for browsing the data of the EPG? If yes, go to step 324; otherwise, go to step 320.

Step 324: Dynamically update the auxiliary display data corresponding to related information of a selected program within the EPG according to the browse instruction, then go to step 320 for displaying the adjusted auxiliary display data.

Since the operating details of the method disclosed in FIG. 3 are similar to that disclosed in FIG. 2, those skilled in this art can easily understand steps 302˜310 after reading the flow chart illustrated in FIG. 2; further description is therefore omitted here for brevity.

In step 312, after the digital TV device (set up box 410) determines that the reminder function of the EPG is enabled (that is, the user sets the status of the EPG function of the reminder menu 100 of FIG. 1 as “Enable”), the EPG can be displayed on a portion of the screen 400 as the message list according to the operation of the user.

In an embodiment of the present invention, the message list of the auxiliary display data of the EPG is displayed in a marquee manner. In addition, the aforementioned adjusted operation corresponding to the auxiliary display data includes firstly displaying a reminder icon on the screen 400 after checking the user has enabled the reminder function of the EPG (for instance, in step 314, after the digital TC device (set up box 410) receives the instruction for enabling the reminder function corresponding to the EPG; however, please note that in the present invention the enabling operation of the corresponding reminder functions can be executed by the user arbitrarily.

When the reminder icon has been displayed on the screen 410, the user can press the corresponding hot key for outputting a confirmation instruction to the digital TV device (the set up box 410) if the user wants to read the auxiliary display data on the screen (step 326).

After receiving the confirmation instruction, the disclosed short message display interface displays the data with corresponding flag values “1” in step 214 and step 218. That is, data corresponding to the digital programs with changes in their program name and/or their program times will be displayed on a portion of the screen 400 (such as the bottom place of the screen 400 as FIG. 5). FIG. 5 is a diagram illustrating the auxiliary display data of the EPG on the screen.

As shown in FIG. 5, the auxiliary display data includes the channel number, the channel name, the changed runtime of the TV program, and any other changed data of the channel. The content of the auxiliary display data differs depending on the design requirements. In other embodiments of the present invention, the user can set the content of the auxiliary display data.

Moreover, the user can use the short message display interface to display/browse the EPG by pressing a corresponding button on a remote controller (not shown) to thereby read the following program list of one selected channel, or read all the program data of different channels that have a same runtime on a portion of the screen 400. In other words, the digital TV device (the set up box 410) updates the auxiliary display data and displays the updated auxiliary display data on the screen 400 according to the browse instruction outputted by the user after the user inputs the confirmation instruction toward the digital TV device (the set up box 410) in step 324 and step 320.

User can also use the aforementioned short message display interface to browse the EPG independently; that is, in another embodiment, no matter whether the content of the EPG varies or not, the user can still user the short message display interface to display/browse the EPG (step 324, 328), and this alternative design also falls within the scope of the present invention.

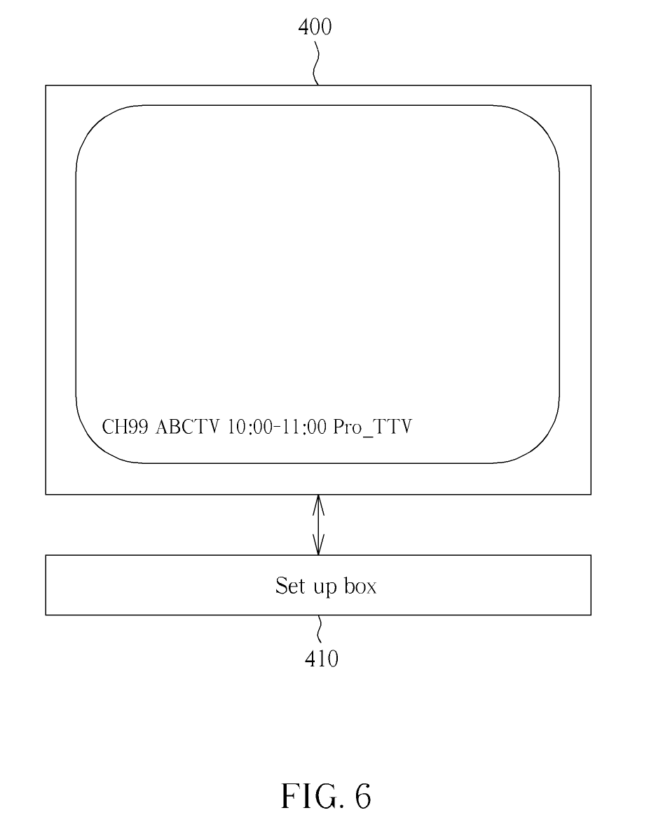

For instance, as shown in FIG. 5, the short message display interface displays the following auxiliary display data on the screen 400: the 99^{th} channel, ABCTV station will broadcast the program “Pro_ABC” at pm 9:00˜pm 10:00. After the user presses the hot keys corresponding to browsing different runtimes on the remote controller (e.g., arrow keys), the short message display interface then displays the auxiliary display data corresponding to the next program of the same channel (99^{th} channel in this embodiment) on a portion (partial area) of the screen 400, as shown in FIG. 6.

That is, the screen 400 at this time displays both the program of the selected channel (i.e., the main display data) and the auxiliary display data (e.g., 99^{th} ABCTV 10:00˜11:00 Pro_TTV) on a partial area at the bottom of the screen 400.

Furthermore, the user can use the auxiliary display data on the screen 400 for reading the related information of programs broadcast at the same time slot in other adjacent channels.

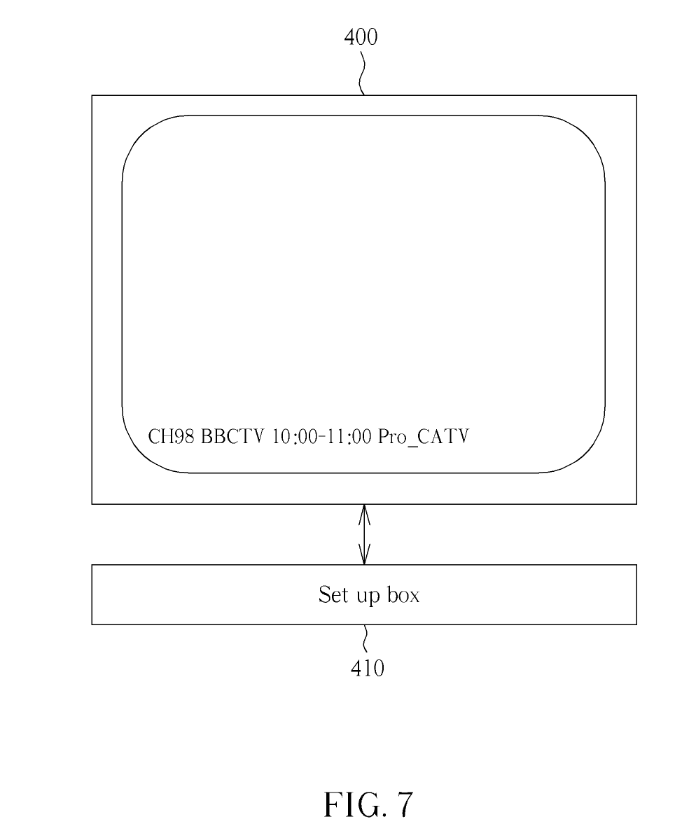

Please refer to FIG. 6 in conjunction with FIG. 7; FIG. 6 and FIG. 7 are diagrams illustrating utilizing the short message display interface to browse the auxiliary display data of other channels on the screen 400 according to an embodiment of the present invention. As shown in FIG. 6 and FIG. 7, the user can utilize hot keys corresponding to browsing different channels on the remote controller (e.g., up and down keys in this embodiment) to control the short message display interface to display the auxiliary display data corresponding to programs with the same runtime in adjacent channels on a partial area on the screen 400 while continuously broadcasting programs of the currently selected channel.

That is, the screen 400 of the set up box 410 broadcasts the program of the select channel and displays the following auxiliary display data on the bottom of the screen 410 (FIG. 7): 98^{th} BBCTV pm 10:00˜pm 11:00 Pro_CATV. The user can use the aforementioned up/down hot keys on the remote controller to further browse the auxiliary display data with the same runtime (pm 10:00˜pm 11:00) of other channels.

From the disclosed method for dynamically displaying the auxiliary display data on the screen, the user hence can watch the program broadcasting in the selected digital channel (displayed on the main part of the screen 400) and browse the auxiliary display data illustrating program data of other runtimes/other channels simultaneously by displaying the auxiliary display data on a partial area of the screen 400. In this manner, the user no longer has to view the full screen EPG data and be forced to interrupt a currently viewed program.

In this embodiment, the reminder icon (i.e., start sign in FIG. 4) is used to reminder the user there are the auxiliary display data that the user can search. In addition, the display manner of the auxiliary display data in this embodiment is a marquee manner in the partial area of the screen 400 (e.g., the portion near edges of the screen 400). This is merely for illustration purposes and is not intended as a limitation to the present invention. That is, shape, type, size, display place, and display manner can vary depending on other design requirements, and these alternative designs also fall within the scope of the present invention.

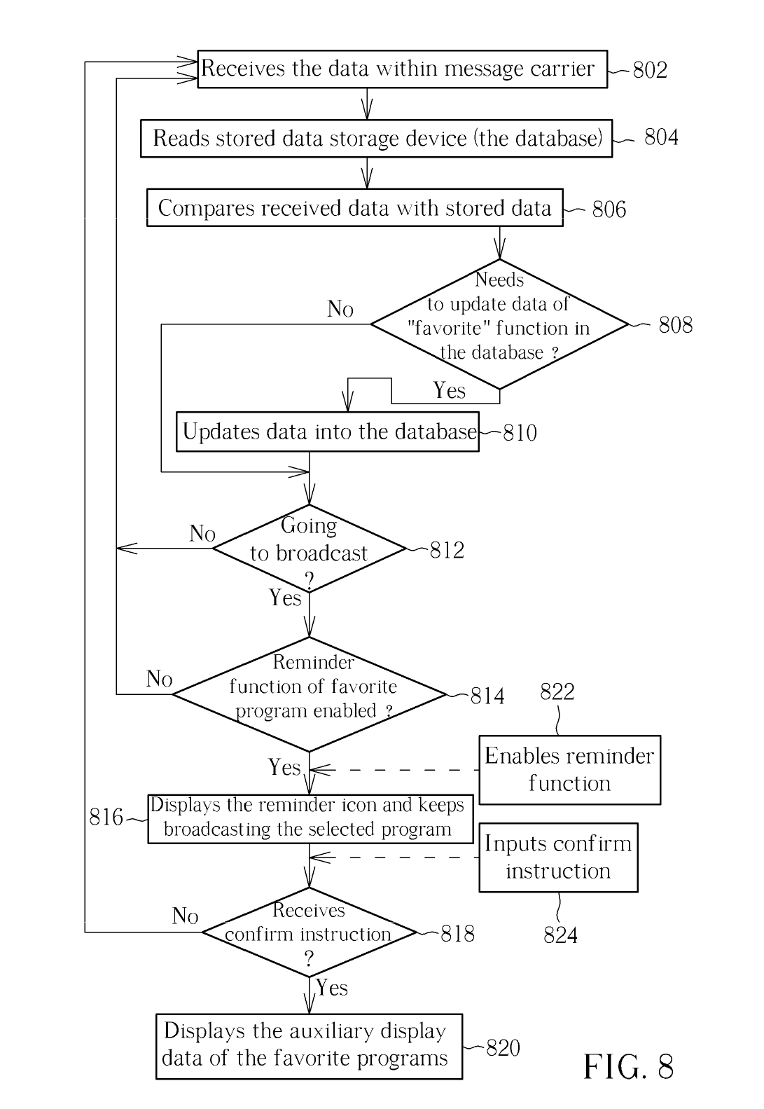

Please refer to FIG. 8, FIG. 8. is a flow chart illustrating dynamic displaying of an auxiliary data of the favorite programs (the “favorite” function) according to an embodiment of the present invention. Please note that, if the result is substantially the same, the steps are not limited to be executed according to the exact order shown in FIG. 8. The flow includes the following steps:

Step 802: The digital TV device (the set top box 410 of FIG. 4) receives a message carrier (e.g., a TV carrier), and stores at least a data (e.g., EPG) transmitted via the message carrier into a storage device.

Step 804: Read the stored data (the stored EPG) from the storage device (the database).

Step 806: Compare the received data with the stored data (i.e., compare the received EPG and the data of stored EPG within the database).

Step 808: Is it required to update data corresponding to the favorite programs set in the “favorites” function in the database or not? If yes, go to step 810; otherwise, go to step 802.

Step 810: Update the data corresponding to the favorite programs set in the “favorite” function into the database.

Step 812: The digital TV device (the set top box 410 of FIG. 4) checks if there are any favorite programs in the “favorite” function that the reminder menu 100 is going to broadcast. (That is, is a time interval between the broadcasting time of the favorite program and a present time smaller than a threshold value)? If yes, enable a countdown function for calculating the length of time for the following favorite program, i.e. if a threshold value of the favorite function is ten minutes in this embodiment, the countdown function will be operated at ten minutes before the favorite program, and go to step 814; otherwise, go to step 802.

Step 814: The digital television device (set up box 410) checks if a reminder function corresponding to favorite program (“favorite” function) within the reminder menu 100 is enabled or not? If yes, go to step 816; otherwise, go to step 802.

Step 816: The screen 400 coupled to the digital television device (set up box 410) displays the reminder icon (start sign) on a partial area of the screen 400; the screen 400 at this time keeps broadcasting the selected program. (Please refer to FIG. 4 in conjunction).

Step 818: Check whether a confirmation instruction is received from the user or not for enabling the auxiliary display data corresponding to the countdown data of the favorite programs? If yes, go to step 820; otherwise, go to step 302.

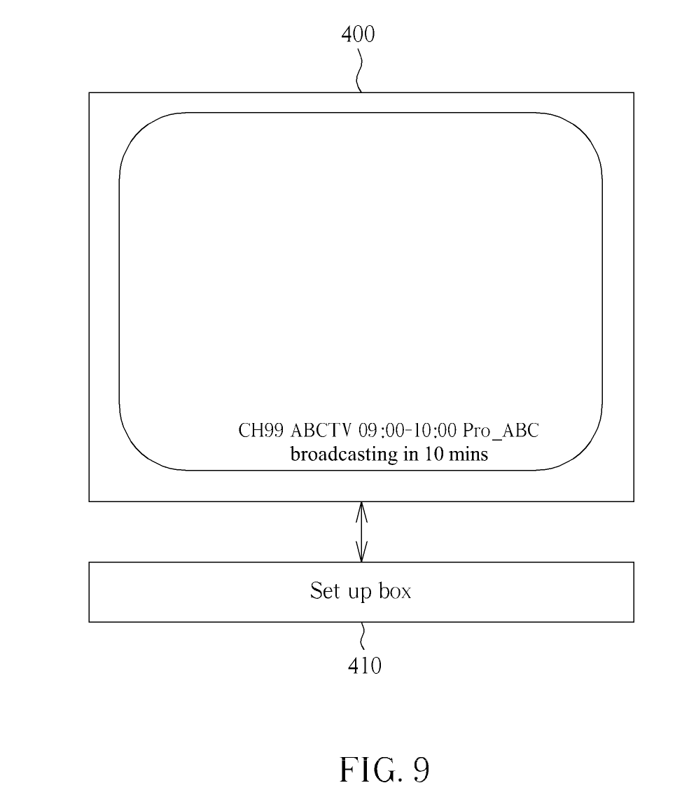

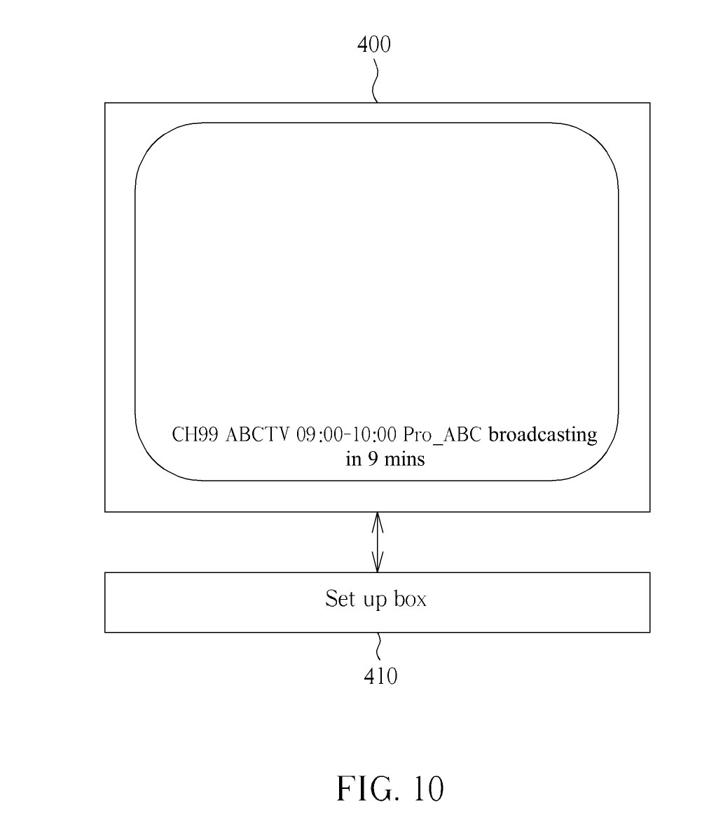

Step 820: Display the auxiliary display data corresponding to the countdown data of the favorite programs at a portion of the screen 400 while displaying the selected digital TV program on the digital TV device (the set top box 410), wherein the auxiliary display data is displayed on a portion of the screen 400 by a message line (as shown in FIG. 9 and FIG. 10).

Please refer to FIG. 9 in conjunction with FIG. 10. FIG. 9 and FIG. 10 are respective diagrams illustrating displaying the auxiliary display data corresponding to the favorite programs on the screen 400 coupled to the digital television device (set up box 410) at different times.

After the user enables the reminder function of the favorite programs, (for instance, in step 822, the digital television device/set up box 410 receives the confirmation instruction inputted by the user for enabling the “favorite” function, and the reminder function of the favorite programs disclosed above can be enabled at any time), when the reminder icon is displayed on the screen 400, the user at this time can output a confirmation instruction toward the digital television device (set up box 410) by pressing the corresponding hot key (step 822).

In this embodiment, after receiving the confirmation instruction, the short message display interface will thereby display the corresponding countdown data on the partial area of the screen 400 while continuing to broadcast the program of the selected program on the main area of the screen 400. That is, the auxiliary display data corresponding to the countdown data of the following favorite program will be displayed in a message list manner on a partial area of the screen 400.

Since the display method of the auxiliary display data corresponding to the favorite programs is similar to the display method of the auxiliary display data corresponding to the EPG, further descriptions are omitted here for brevity.

Similarly, in this embodiment, the reminder icon (i.e., start sign in FIG. 4) is used to remind the user there are auxiliary display data that the user can search. In addition, the display manner of the auxiliary display data in this embodiment is a marquee manner in the partial area of the screen 400 (e.g., the portion near edges of the screen 400). Shape, type, size, display place, and display manner can vary depend on other design requirements.

Furthermore, for the digital television device capable of broadcasting the selected channel and recording other programs simultaneously (that is, the set up box 410 at this time is a digital set up box with a PVR function), the user can combine the aforementioned short message display interface with both the searching management and the corresponding settings of the reminder menu. The user hence can enable/stop the recording operation by the short message display interface and the operations of the remote controller. The detailed descriptions are disclosed as follows.

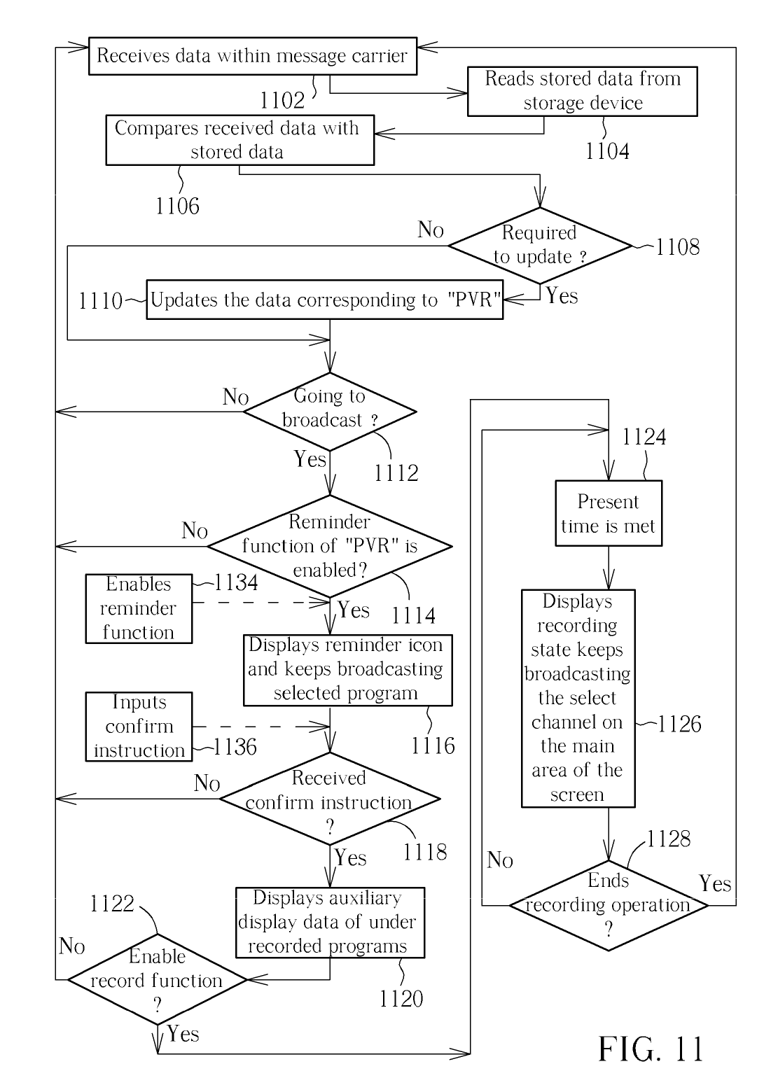

Please refer to FIG. 11, FIG. 11. is a flow chart illustrating dynamic displaying of the auxiliary data corresponding to the PVR function according to an embodiment of the present invention. Please note that, if the result is substantially the same, the steps are not limited to be executed according to the exact order shown in FIG. 8. The flow includes the following steps:

Step 1102: The digital TV device (the set top box 410 of FIG. 4) receives a message carrier (e.g., a TV carrier), and stores at least a data (e.g., EPG) transmitted via the message carrier into a storage device.

Step 1104: Read the stored data (e.g., the stored EPG) from the storage device (the database).

Step 1106: Compare the received data with the stored data (i.e., compare the received EPG and the data of stored EPG within the database).

Step 1108: Is it required to update data (e.g., program name and/or program runtime) corresponding to the programs set in the “PVR” function in the database or not? If yes, go to step 1110; otherwise, go to step 1112.

Step 1110: Update the data corresponding to the programs set in the “PVR” function in the database.

Step 1112: The digital TV device (the set top box 410 of FIG. 4) checks if there are any programs set in the “PVR” function that are going to broadcast or not. (That is, is a time interval between the broadcasting time of the under recorded program set by the aforementioned “PVR” function and a present time smaller than a threshold range)? If yes, go to step 1114; otherwise, go to step 1102.

Step 1114: The digital television device (set up box 410) checks if a reminder function corresponding to the “PVR” function within the reminder menu 100 is enabled or not? If yes, go to step 1116; otherwise, go to step 1102.

Step 1116: The screen 400 coupled to the digital television device (set up box 410) displays the reminder icon (start sign) on a partial area of the screen 400 (e.g., at the bottom of the screen 400); the screen 400 at this time keeps broadcasting the selected program at the main area. (Please refer to FIG. 4 in conjunction).

Step 1118: Check if a confirmation instruction for enabling the auxiliary display data corresponding to the reminder data of the “PVR” function is received from the user or not (for instance, in step 1136 the user outputs a confirmation signal to the digital television device/set up box 410 by pressing the corresponding reminder hot key). If yes, go to step 1120; otherwise, go to step 1102.

Step 1120: Display the auxiliary display data corresponding to the related auxiliary data of the under recorded programs at a portion of the screen 400 while displaying the selected digital TV program on the digital TV device (the set top box 410) (e.g., display a word message on a portion of the screen 410 to remind the user that one of the to be recorded programs is going to broadcast after a minute), wherein the auxiliary display data is displayed on a portion (partial area) of the screen 400 by a message line.

Step 1122: Check whether to enable a record function or not. If yes, go to step 1124; otherwise, go to step 1102.

Step 1124: When a present time is that same as the broadcast time, enable a recording operation of the to-be-recorded program.

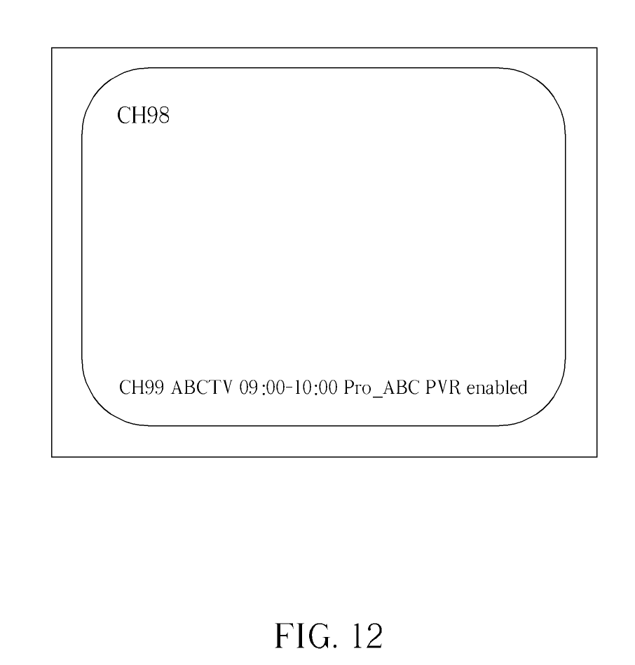

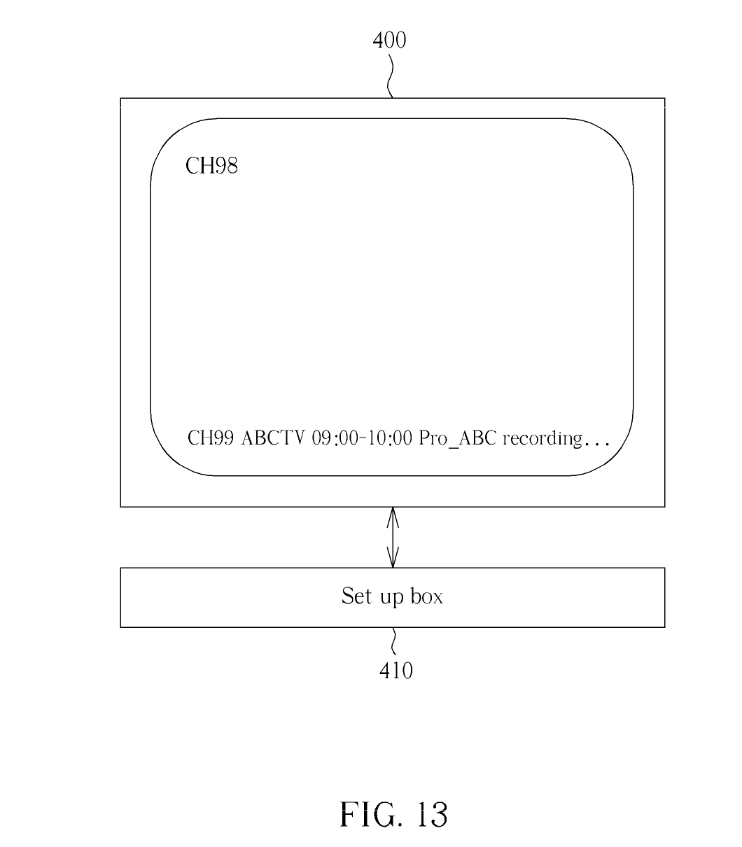

Step 1126: Display a recording state at a partial area of the screen 400 by the short message display interface and keep broadcasting the select channel on the main area of the screen 400 of the digital television device (set up box 410). That is, inform the user that the recording operation is operating when enabling the recording operation (FIG. 12), and in the recording process inform the user of the recording time and the program name on a partial area of the screen 400 (as shown in FIG. 13).

Step 1128: The digital television device (set up box 410) determines whether to end the recording operation or not. When the digital television device (set up box 410) receives an end instruction of the recording operation from the user, the recording operation of the program set in the “PVR” function finishes, or the user switches to the channel of the to-be-recorded program, the digital television device (set up box 410) ends the recording operation and goes to step 1102; otherwise, go to step 1124 for continuing the recording operation.

In general, digital television devices now have two or more tuners and hence are capable of receiving data of two different channels simultaneously to enable the user to watch a program of one channel and record a program of another channel at the same time.

Since the display method of the auxiliary display data corresponding to the to-be-recorded programs (under-recorded programs) corresponding to the “PVR” function is similar to the display method of the auxiliary display data corresponding to the EPG, further descriptions are omitted here for the sake of brevity.

In conclusion, in the aforementioned disclosure, the digital television device (set up box) receives a data from a message carrier as a received data and compares the received data with a stored data in the storage device, and when the received data is different from the stored data, updates the stored data by storing the received data.

After the user sets (selectively enables) the desired function in the reminder menu, the digital television device dynamically uses the stored data in the storage device to communicate with the user through a user interface according to the functional options set by the user; hence, the digital television device dynamically displays the desired auxiliary display data on the screen for the user to browse by executing the adjusting operation according to user requirements while watching the selected channel. By the disclosed method, a method for enabling the user to receive the required auxiliary display data in a simple and convenient way and watch the selected channel simultaneously without interruption is provided.

In addition, with proper modulation, the disclosed method for dynamically displaying the auxiliary display data on the screen can also be applied in the “sleep timer” function for displaying related information of an automatic turn off operation as well as the “common interface” function for displaying related information of a payment certificate state. For instance, when the auxiliary data display function corresponding to the “sleep timer” function is enabled and a remaining time for automatically closing the electronic device (e.g., the digital television device) exceeds a predetermined value, the auxiliary display data related to automatically closing the electronic device will be displayed on a partial area of the screen 400 by applying the disclosed method of the present invention.

Furthermore, when the auxiliary data display function corresponding to the “common interface” function is enabled, the auxiliary display data corresponding to the payment certificate state will be displayed on a partial area of the screen 400 by applying the disclosed method of the present invention.

Since the operating details of displaying the auxiliary display data corresponding to the “sleep timer” function and the “common interface” function are similar to those disclosed in FIG. 3, FIG. 8 and FIG. 10, those skilled in this art can easily understand the scheme of displaying the auxiliary display data corresponding to the “sleep timer” function and the “common interface” function after reading the flow charts illustrated in FIG. 3, FIG. 8 and FIG. 11; further description is therefore omitted here for brevity.

In other embodiments, the present invention may also be applied in an on-line transaction (e.g., TV shopping). For instance, in one embodiment of the present invention, by cooperation with the digital shopping station (e.g., through the DVB-C system), confirmation messages for personal order processes and/or personal order notifications for the user can be displayed on the screen 400 in the disclosed auxiliary display data through the assistance device. That is, by combining the digital television broadcasting provider and the disclosed method for dynamically displaying the auxiliary display data, the individual reminder data (e.g., information for notifying the user that the on-line transaction has been successfully finished) can be displayed on the screen 400 by utilizing the short message display interface of an individual user.

Please notice that the present invention can also be applied to any electronic devices such as an MP3 walkman, a personal computer or a video game device that has requirements for simple and convenient auxiliary display data as well as applying to the digital television device that receives the aforementioned main display data from the message carries (a TV carrier). In this way, the present invention provides the user with a simpler, convenient, and personalized user environment without interrupting the operating state of the electronic device. These alternative designs also fall within the scope of the present invention.

In conclusion, the disclosed method for dynamically displaying the auxiliary display data on the screen regularly checks if the display condition corresponding to the auxiliary display data is met (e.g., step 308, 312, 318, 312; step 812, 814, and 818; and step 1112, 1114, 1118), for selectively reminding the user with auxiliary display data.

Furthermore, the disclosed method merges the auxiliary display data and the main display data to generate the adjusted main display data to display the adjusted main display data when the display condition is met, wherein the adjusted main display data contains the auxiliary display data. A partial data of the main display data is replaced by the auxiliary display data to form the adjusted main display data, by using a partial display area on the screen to display the auxiliary display data (e.g., in a marquee manner or in a word message manner) as the auxiliary display data overlays a part of the main display data while displaying digital signal on the screen.

Although the present invention has been described with reference to the preferred embodiments thereof, it will be understood that the present invention is not limited to the details thereof. Those skilled in the art will readily observe that numerous modifications and alterations of the device and method may be made while retaining the teachings of the invention.

What is claimed is:

1. A method for dynamically displaying an auxiliary display data on a screen, comprising:
(a) receiving a message carrier and storing at least a data transmitted via the message carrier into a storage device;
(b) comparing a received data of the message carrier with a stored data of the storage device; and when the received data differs from the stored data, storing the received data into the storage device for updating the stored data, thereby generating an updated stored data stored in the storage device; and
(c) determining whether to display the auxiliary display data corresponding to an altered portion or not, wherein an adjusting operation is performed according to the updated stored data when the auxiliary display data is displayed, to thereby display the auxiliary display data on the screen.

2. The method of claim 1, wherein the step (c) comprises: determining to display the auxiliary display data corresponding to the altered portion when an auxiliary display function corresponding to an electronic program guide (EPG) is enabled and a content of the EPG is changed; and the adjusting operation comprises:
(d) setting the auxiliary display data according to related information of at least a changed program, and combining the auxiliary display data with a main display data to thereby generate an adjusted main display data for the auxiliary display data displayed via the adjusted main display data on the screen.

3. The method of claim 2. wherein the adjusting operation further comprises:
setting the auxiliary display data according to a reminder icon, and combining the auxiliary display data with the main display data to thereby generate the adjusted main display data for the auxiliary display data corresponding to the reminder icon displayed via the adjusted main display data on the screen;
determining if a confirmation instruction corresponding to the reminder icon is received or not; and
executing the step (d) when the confirmation instruction is received.

4. The method of claim 2, wherein the adjusting operation further comprises:
determining if a browse instruction is received or not; and
when the browse instruction is received, setting the auxiliary display data according to related information of a selected program in the EPG that is determined by the browse instruction, and combining the auxiliary display data with a main display data to thereby generate an adjusted main display data for the auxiliary display data displayed via the adjusted main display data on the screen.

5. The method of claim 1, wherein the step (c) comprises determining that a display condition corresponding to the auxiliary display data is met when an auxiliary display function corresponding to a favorite program is enabled; and the adjusting operation sets the auxiliary display data according to related information of the favorite program and combines the auxiliary display data with a main display data to thereby generate an adjusted main display data for the auxiliary display data corresponding to the related information of the favorite program displayed via the adjusted main display data on the screen.

6. The method of claim 5, wherein the related information of the favorite program comprises a user-defined countdown data for playback of the favorite program after a predetermined time is reached.

7. The method of claim 1, wherein the step (c) comprises determining a display condition corresponding to the auxiliary display data is met when an auxiliary display function corresponding to an under-recorded program is enabled; and the adjusting operation sets the auxiliary display data according to related information of the under-recorded program and combines the auxiliary display data with a main display data to thereby generate an adjusted main display data for the auxiliary display data corresponding to the related information of the under-recorded program displayed via the adjusted main display data on the screen.

8. The method of claim 1, wherein the step (c) comprises determining a display condition corresponding to the auxiliary display data being met when an auxiliary display function corresponding to a payment certificate state is enabled; and the adjusting operation sets the auxiliary display data according to related information of the payment certificate state and combines the auxiliary display data with a main display data to thereby generate an adjusted main display data for the auxiliary display data corresponding to the related information of the payment certificate state displayed via the adjusted main display data on the screen.

9. The method of claim 1, further comprising:
receiving related information of an on-line transaction from the message carrier;
wherein the step (c) determines a display condition corresponding to the auxiliary display data being met when an auxiliary display function corresponding to the on-line transaction is enabled; and the adjusting operation sets the auxiliary display data according to the related information of the on-line transaction, and combines the auxiliary display data with a main display data to thereby generate an adjusted main display data for the auxiliary display data corresponding to the related information of the on-line transaction displayed via the adjusted main display data on the screen.

10. A method for dynamically displaying an auxiliary display data on a screen, comprising:
regularly checking if a display condition for the auxiliary display data is met; and
when the display condition for the auxiliary display data is met, combining the auxiliary display data with a main display data to thereby generate an adjusted main display data and displaying the adjusted main display data;
wherein the adjusted main display data contains the auxiliary display data.

11. The method of claim 10, wherein regularly checking if the display condition for the auxiliary display data is met comprises:
determining that the display condition corresponding to the auxiliary display data is met when an auxiliary display function corresponding to an electronic program guide (EPG) is enabled and a content of the EPG is changed; and
combining the auxiliary display data with the main display data to thereby generate the adjusted main display data and displaying the adjusted main display data comprises:
(a) setting the auxiliary display data according to related information of at least a changed program;
combining the auxiliary display data with the main display data to thereby generate the adjusted main display data; and
displaying the adjusted main display data.

12. The method of claim 11, wherein combining the auxiliary display data with the main display data to thereby generate the adjusted main display data and displaying the adjusted main display data further comprises:
setting the auxiliary display data according to a reminder icon, combining the auxiliary display data with the main display data to thereby generate the adjusted main display data, and displaying the adjusted main display data;
checking if a confirmation instruction corresponding to the reminder icon is received; and
executing the step (a) when receiving the confirmation instruction.

13. The method of claim 11, wherein combining the auxiliary display data with the main display data to thereby generate the adjusted main display data and displaying the adjusted main display data further comprises:
checking if a browse instruction is received; and
when receiving the browse instruction, setting the auxiliary display data according to related information of a selected program in the EPG that is determined by the browse instruction, combining the auxiliary display data with the main display data to thereby generate the adjusted main display data, and displaying the adjusted main display data.

14. The method of claim 10, wherein regularly checking if the display condition for the auxiliary display data is met comprises:
determining the display condition corresponding to the auxiliary display data is met when an auxiliary display function corresponding to a favorite program is enabled; and
combining the auxiliary display data with the main display data to thereby generate the adjusted main display data and displaying the adjusted main display data comprises:
(a) setting the auxiliary display data according to related information of the favorite program;
combining the auxiliary display data with the main display data to thereby generate the adjusted main display data; and
displaying the adjusted main display data.

15. The method of claim 14, wherein combining the auxiliary display data with the main display data to thereby generate the adjusted main display data and displaying the adjusted main display data further comprises:
setting the auxiliary display data according to a reminder icon, combining the auxiliary display data with the main display data to thereby generate the adjusted main display data, and displaying the adjusted main display data;
checking if a confirmation instruction corresponding to the reminder icon is received; and
executing the step (a) when receiving the confirmation instruction.

16. The method of claim 14, wherein the related information of the favorite program comprises a user-defined countdown data for playback of the favorite program after a predetermined time is reached.

17. The method of claim 10, wherein regularly checking if the display condition for the auxiliary display data is met comprises:
determining the display condition corresponding to the auxiliary display data is met when an auxiliary display function corresponding to an under-recorded program is enabled; and
combining the auxiliary display data with the main display data to thereby generate the adjusted main display data and displaying the adjusted main display data comprises:
setting the auxiliary display data according to related information of the under-recorded program, combining the auxiliary display data with the main display data to thereby generate the adjusted main display data, and displaying the adjusted main display data.

18. The method of claim 10, wherein regularly checking if the display condition for the auxiliary display data is met comprises:
determining the display condition corresponding to the auxiliary display data is met when an auxiliary display function corresponding to a payment certificate state is enabled; and
combining the auxiliary display data with the main display data to thereby generate the adjusted main display data and displaying the adjusted main display data comprises:
setting the auxiliary display data according to related information of the payment certificate state, combining the auxiliary display data with the main display data to thereby generate the adjusted main display data, and displaying the adjusted main display data.

19. The method of claim 10, wherein the auxiliary display data of the adjusted main display data is displayed by a marquee manner.

20. The method of claim 10, further comprising:
receiving the main display data from a television carrier.

21. The method of claim 20, further comprising:
receiving related information of an on-line transaction from the television carrier;
wherein regularly checking if the display condition for the auxiliary display data is met comprises:
determining the display condition corresponding to the auxiliary display data is met when an auxiliary display function corresponding to the on-line transaction is enabled; and
combining the auxiliary display data with the main display data to thereby generate the adjusted main display data and displaying the adjusted main display data comprises:
setting the auxiliary display data according to the related information of the on-line transaction, combining the auxiliary display data with the main display data to thereby generate the adjusted main display data, and displaying the adjusted main display data.
